(19) United States
(12) Patent Application Publication
(10) Pub. No.: US 2021/0246322 A1
(43) Pub. Date: Aug. 12, 2021

(54) Inkjet Inks

(71) Applicant: KYOCERA Document Solutions Inc., Osaka-shi (JP)

(72) Inventor: Ryotaro Komada, Osaka-shi (JP)

(21) Appl. No.: 17/163,696

(22) Filed: Feb. 1, 2021

(30) Foreign Application Priority Data
Feb. 6, 2020 (JP) 2020-019196

(51) Int. Cl. C09D 11/104; C09D 11/328; B41M 5/00; B41M 7/00

(52) U.S. Cl. CPC C09D 11/104; C09D 11/328; B41M 7/009; B41M 5/0047; B41M 5/0023

(57) ABSTRACT

The ink contains an aqueous medium and composite particles. The composite particles are particles of a composite of a polyester resin having a sulfonic acid group and a basic dye. The polyester resin has a first, repeating unit, derived from a polycarboxylic acid having a sulfonic acid group, a second repeating unit derived from a polycarboxylic acid having no sulfonic acid group, and a third repeating unit derived from a polyhydric alcohol. The content ratio of the first repeating unit to the total amount of the first repeating unit and the second repeating unit is 1.5 mol % or more and 10.0 mol % or less. The acid value of the polyester resin is 15 mgKOH/g or more and 80 mgKOH/g or less. The mass ratio of the polyester resin to the basic dye is 1.0 or more and 10.0 or less.

### INCORPORATION BY REFERENCE

This application is based on and claims the benefit of priority from Japanese Patent application No. 2020-019196 filed on Feb. 6, 2020, which is incorporated by reference in its entirety.

### BACKGROUND

The present disclosure relates to inkjet inks.

In printing by the inkjet recording method, inkjet ink is ejected from a recording head of an inkjet recording apparatus to print an image on a recording medium. Some inkjet inks include, for example, polymer particles dyed with basic dyes.

### SUMMARY

An inkjet ink according to an embodiment of the present disclosure includes an aqueous medium and composite particles. The composite particles are particles of a composite of a polyester resin having a sulfonic acid group and a basic dye. The polyester resin has a glass transition point of 40 degrees centigrade or higher and 70 degrees centigrade or lower. The polyester resin has a first repeating unit derived from a polycarboxylic acid having a sulfonic acid group, a second repeating unit derived from a polycarboxylic acid not having a sulfonic acid group, and a third repeating unit derived from a polyhydric alcohol. The content ratio of the first repeating unit to the total amount of the first repeating unit and the second repeating unit is 1.5 mol % or higher and 10.0 mol % or lower. The acid value of the polyester resin is 15 mgKOH/g or higher and 80 mgKOH/g or lower. The mass ratio of the polyester resin to the basic dye is 1.0 or higher and 10.0 or lower.

### DETAILED DESCRIPTION

### [Inkjet Ink]

The inkjet ink of the present embodiment (hereinafter, simply referred to as “ink” in some cases) will be described. The ink of the present embodiment can be used as an ink for digital textile printing for printing an image on a textile product such as a cloth using an inkjet recording apparatus for example. Compared with screen printing and rotary screen printing, digital textile printing has an advantage that a step of removing a sizing agent is unnecessary and an advantage that dyeing waste water can be reduced.

The ink of the present embodiment is an aqueous ink containing an aqueous medium and composite particles. Because the ink contains the composite particles, an image excellent in frictional fastness in a wet state can be printed while suppressing the occurrence of image defects, and degrading of a feeling of a recording medium (for example, a textile product such as a polyester fabric or a cotton fabric) on which an image is printed can be suppressed. Hereinafter, the frictional fastness of an image in a wet state may be referred to as “wet frictional fastness”. Hereinafter, the frictional fastness of an image in a dry state may be referred to as “dry frictional fastness”. Hereinafter, the composite particles and the aqueous medium will be described.

### [Composite Particles]

The composite particles are particles of a composite of a polyester resin having a sulfonic acid group (hereinafter may be referred to as a specific polyester resin) and a basic dye. In the composite particles, the basic dye and the sulfonic acid group of the specific polyester resin are bonded to each other by an ionic bond for example. The basic dye has a basic group, and this basic group becomes a cationic group in an aqueous medium. A cationic group (for example, —NH₄+) formed from a basic group (for example, amino groups) included in the basic dye and an anionic group (—SO₃—) formed from a sulfonic acid group included in the specific polyester are easily bonded by an ionic bond. When the basic dye and the sulfonic acid group included in the specific polyester resin are bonded to each other by an ionic bond, the basic dye and the sulfonic acid group included in the specific polyester resin are strongly bonded to each other to form a complex.

When the ink contains the composite particles, the following advantages are obtained. When the ink containing the composite particles lands on a recording medium and is subjected to heat treatment, the composite particles are plastically deformed on the recording medium in accordance with plastic deformation of the specific polyester resin. Since the plastically deformed composite particles spread on the surface of the recording medium, an image having high image density can be printed even when a small amount of ink is used. In addition, unlike the bleeding of the dye that spreads along the fibers of the recording medium due to the capillary phenomenon, the dyed area spreads due to the plastic deformation of the composite particles, and thus the image printed using the ink containing the composite particles becomes clear. In addition, when the ink containing the composite particles lands on a recording medium, the recording medium and the composite particles adhere to each other, via the specific polyester resin included in the composite particles which helps improve the degree of friction fastness of the image.

### (Resin/Dye Ratio)

The mass ratio of the specific polyester resin to the basic dye (the mass of the specific polyester resin/the mass of the basic dye) is 1.0 or more and 10.0 or less. Hereinafter, the “mass ratio of the specific polyester resin to the basic dye” may be referred to as “resin/dye ratio”.

When the resin/dye ratio is less than 1.0, the amount of the specific polyester resin is small. Therefore, when the ink containing the composite particles lands on the recording medium, the recording medium and the composite particles are less likely to adhere to each other, and the friction fastness (particularly, the wet friction fastness) is decreased. When the resin/dye ratio is less than 1.0 the amount of the basic dye is large, and the basic dye is less likely to be introduced into the specific polyester resin, and the preparation of the composite particles is difficult.

On the other hand, when the resin/dye ratio exceeds 10.0, the amount of the basic dye is small, and thus the density of the printed image decreases, and image defects such as density unevenness occur. When the resin/dye ratio exceeds 10.0, the amount of the specific polyester resin is large. Therefore, the image printed on the recording medium using the ink containing the composite particles becomes stiff due to the specific polyester resin, and the feel of the recording medium on which the image is printed (for example, resistance to swelling and stiffness) decreases. In addition, when the resin/dye ratio exceeds 10.0, the amount of the specific polyester resin increases, and therefore, in an image printed on a recording medium using an ink containing composite particles, sliminess due to the specific polyester resin occurs, and the tactile feeling of the recording medium on which the image is printed decreases. On the other hand, when the resin/dye ratio exceeds. Also, when the resin/dye ratio exceeds 10.0, the friction fastness (especially wet friction fastness) also decreases.

In order to obtain an ink that can print an image having a higher degree of wet friction fastness while suppressing the occurrence of image defects and can suppress the decrease in the sense of touch of the recording medium on which the image is printed, the resin/dye ratio is preferably 2.0 or more and 8.0 or less, and more preferably 2.5 and more and 7.5 or less.

The resin/dye ratio can be adjusted by varying the amount of basic dye used to prepare the composite particles relative to the amount of specific polyester resin used to prepare the composite particles.

### (Predetermined Conductivity)

The conductivity of the dispersion liquid in which the composite particles are dispersed in water at a concentration of 5% by mass is preferably 30 μS/cm or less. Hereinafter, the “conductivity of the dispersion liquid in which the composite particles are dispersed in water at a concentration of 5% by mass” may be referred to as a “predetermined conductivity”. The predetermined conductivity of the composite particles is an index indicating the amount of the counter ion contained in the basic dye constituting the composite particles. The lower the predetermined conductivity of the composite particles, the less the amount of counter ions contained in the basic dye.

Because basic dyes are often produced by salting out, basic dyes often contain counter ions (e.g., Cl—, SO₄²—, PO₄³—, and CO₃²—) that stabilize the dye in water. However, when the counter ions are contained in the ink, inorganic salt impurities (e.g., NaCl, Na₂SO₄, Na₃PO₄, and CaCO₃) may be generated from the counter ions. Then, the generated inorganic salt impurities may adhere to the inside of the nozzle of the recording head included in the inkjet recording apparatus, and the clogging of the nozzle and the ejection deviation of the ink from the nozzle may be caused.

When the predetermined conductivity of the composite particles is 30 μS/cm or less, the amount of counter ions contained in the basic dye is relatively small. Therefore the amount of generated inorganic salt impurities is reduced, and it is possible to suppress nozzle clogging and ink ejection deviation from the nozzle. As a result, it is possible to suppress the occurrence of an image defect such as an image streak caused thereby.

The predetermined conductivity of the composite particles is preferably 15 μS/cm or less, and more preferably 13 μS/cm or less, in order to suppress nozzle clogging and ink ejection deviation from the nozzle. The lower limit, of the predetermined conductivity of the composite particles is not particularly limited, but the predetermined conductivity of the composite particles is, for example, 0 μS/cm or more.

As an example of a method for adjusting the predetermined conductivity of the composite particles, cleaning treatment of the composite particles with water (for example, ion-exchanged water) is given. The greater the number of times the cleaning treatment is performed, the lower the predetermined conductivity of the composite particles becomes. The details of the cleaning treatment will be described in the <Ink Manufacturing Method> described later and the examples described later. As another example of a method for adjusting the predetermined conductivity of the composite particles, there is a method of dehydrating the composite particles using a centrifuge. As still another example of the method for adjusting the predetermined conductivity of the composite particles, there is a method of purifying the composite particles using an ultrafiltration membrane, a reverse osmosis membrane, or an ion exchange resin. The predetermined conductivity of the composite particles can be measured by the method described in the Examples to be described later.

The content of the composite particles is preferably 0.1% by mass or more and 30.0% by mass or less, more preferably 0.1% by mass or more and 10.0% by mass or less with respect to the mass of the ink.

### (Specific Polyester Resin Constituting Composite Particles)

Since the specific polyester resin has a sulfonic acid group, the specific polyester resin is strongly complexed with a basic dye having a basic group (for example, an amino group). The sulfonic acid group of the specific polyester resin in the composite particles may be present in a salt state.

The specific polyester resin has a first repeating unit, a second repeating unit, and a third repeating unit. The first repeating unit is a repeating unit derived from a polycarboxylic acid having a sulfonic acid group. The second repeating unit is a repeating unit derived from a polycarboxylic acid having no sulfonic acid group. The third repeating unit is a repeating unit derived from a polyhydric alcohol.

The specific polyester resin is obtained by condensation polymerization of a first monomer, a second monomer, and a third monomer. That is the specific polyester resin is a condensation polymer of the first monomer, the second monomer, and the third monomer. The first monomer is a polycarboxylic acid having a sulfonic acid group. The second monomer is a polycarboxylic acid having no sulfonic acid group. The third monomer is a polyhydric alcohol. By condensation polymerization, the first monomer, the second monomer, and the third monomer form the first repeating unit, the second repeating unit, and the third repeating unit, respectively. That is the first repeating unit, the second repeating unit, and the third repeating unit are a repeating unit derived from the first monomer, a repeating unit derived from the second monomer and a repeating unit derived from the third monomer, respectively.

The content ratio of the first repeating unit with respect to the total amount (total material amount) of the first repeating unit and the second repeating unit is 1.5 mol % or more and 10.0 mol % or less. Hereinafter, “the content of the first repeating unit with respect to the total amount of the first repeating unit and the second repeating unit” may be described as “the first repeating unit ratio”.

The sulfonic acid group included in the first repeating unit imparts water solubility to the specific polyester resin. When the first repeating unit ratio is less than 1.5 mol %, the number of sulfonic acid groups decreases, and thus the water solubility of the specific polyester resin decreases, and it becomes difficult to prepare the composite particles. When the first repeating unit ratio is less than 1.5 mol %, the compatibility of the specific polyester resin with the aqueous medium decreases. Therefore, the dispersibility of the composite particles containing the specific polyester resin in the ink decreases.

On the other hand, when the first repeating unit ratio exceeds 10.0 mol %, the solubility of the specific polyester in water becomes too high. Therefore, the water resistance of an image printed using the ink containing the composite particles decreases, and the wet friction fastness of the image decreases.

In order to obtain an ink capable of printing an image more excellent in wet friction fastness while suppressing the occurrence of image defects and capable of suppressing a decrease in the tactile feeling of a recording medium on which the image is printed, the first repeating unit ratio is preferably 1.5 mol % or more and 8.0 mol % or less, more preferably 1.9 mol % or more and 7.2 mol % or less, and even more preferably 3.0 mol % or more and 3.5 mol % or less.

The first repeating unit ratio can be adjusted, for example, by changing the amount of the first monomer used and the amount of the second monomer used in condensation polymerization of the specific polyester resin. The first repeating unit ratio can be measured, for example, by analyzing the specific polyester resin using a nuclear magnetic resonance apparatus (NMR) and obtaining a ratio of a peak characteristic of the first repeating unit to a peak characteristic of the second repeating unit.

Examples of the first monomer for forming the first repealing unit include a divalent carboxylic acid having a sulfonic acid group. Examples of the divalent carboxylic acid having a sulfonic acid group include sulfoterephthalic acid, 5-sulfoisophthalic acid, 4-sulfophthalic acid, 4-sulfonaphthalene-2,7-dicarboxylic acid, 5-(4-sulfophenoxy) isophthalic acid, and salts thereof. Examples of the salt include an alkali metal salt (more specifically, a lithium salt, a sodium salt, a potassium salt, or the like), a magnesium salt, a calcium salt, a copper salt, an iron salt, and an ammonium salt.

In order to print an image having more excellent wet friction fastness, the first monomer is preferably at least one selected from the group consisting of 5-sulfoisophthalic acid, a salt of 5-sulfoisophthalic acid, 4-sulfophthalic acid, and a salt of 4-sulfophthalic acid, and more preferably at least one selected from the group consisting of 5-sodium sulfoisophthalic acid (also referred to as sodium 5-sulfoisophthalate) and 4-sulfophthalic acid.

In order to print an image more excellent in wet friction fastness, the first repeating unit preferably includes at least one selected from the group consisting of a repeating unit derived from 5-sulfoisophthalic acid, a repeating unit derived from a salt of 5 sulfoisophthalic acid, a repeating unit derived from 4 sulfophthalic acid, and a repeating unit derived from a salt of 4-sulfophthalic acid, more preferably includes at least one selected from the group consisting of a repeating unit derived from 5-sodium sulfoisophthalic acid and a repeating unit derived from 4-sulfophthalic acid, and still more preferably is at least one selected from the group consisting of a repeating unit, derived from 5-sodium sulfoisophthalic acid and a repeating unit derived from 4-sulfophthalic acid.

The repeating unit derived from 5-sodium sulfoisophthalic acid is represented by the following chemical formula (1A), and the repeating unit derived from 4-sulfophthalic acid is represented by the following chemical formula (1B).

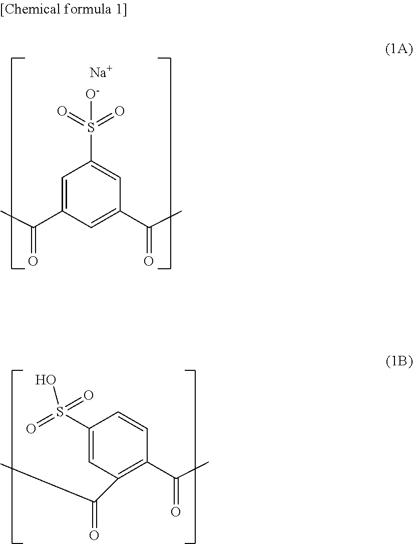

Examples of the second monomer for forming the second repeating unit include aromatic divalent carboxylic acids having no sulfonic acid group, aliphatic divalent carboxylic acids having no sulfonic acid group, alicyclic divalent carboxylic acids having no sulfonic acid group, and trivalent or higher carboxylic acids having no sulfonic acid group. Examples of the aromatic dicarboxylic acid having no sulfonic acid group include terephthalic acid isophthalic acid, naphthalenedicarboxylic acid (e.g. 1,5-naphthalenedicarboxylic acid and 2,6-naphthalenedicarboxylic acid), diphenic acid, and phenylenediacrylic acid. Examples of the aliphatic divalent carboxylic acid having no sulfonic acid group include succinic acid, adipic acid, azelaic acid, sebacic acid, dodecanedicarboxylic acid, fumaric acid, maleic acid, itaconic acid, mesaconic acid, and citraconic acid. Examples of the alicyclic divalent carboxylic acid having no sulfonic acid group include cyclohexanedicarboxylic acid. Examples of the trivalent, or higher carboxylic acid having no sulfonic acid group include trimellitic acid, trimesic acid, and pyromellitic acid.

The second monomer is preferably one or more selected from the group consisting of an aromatic divalent carboxylic acid having no sulfonic acid group and a trivalent or higher carboxylic acid having no sulfonic acid group, and more preferably one or more selected from the group consisting of terephthalic acid, isophthalic acid, naphthalenedicarboxylic acid, and trimellitie acid.

The repeating unit derived from naphthalenedicarboxylic acid is preferably represented by the following chemical formula (2A), and more preferably represented by the following chemical formula (2B).

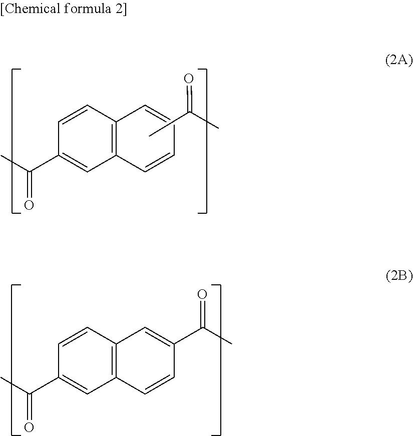

In order to adjust the glass transition point of the specific polyester resin to 70 degrees centigrade or lower, the second monomer preferably contains terephthalic acid and isophthalic acid. For the same reason, the second repeating unit preferably includes a repeating unit derived from terephthalic acid and a repeating unit derived from isophthalic acid.

Examples of the third monomer for forming the third repeating unit include aliphatic polyhydric alcohols, alicyclic polyhydric alcohols, aromatic polyhydric alcohols, and other polyhydric alcohols. The aliphatic polyhydric alcohol is a divalent aliphatic alcohol or a trivalent or higher aliphatic alcohol. Examples of the divalent aliphatic alcohols include ethylene glycol, diethylene glycol, propylene glycol, 1,3-propanediol, 2,3-butanediol, 1,4-butanediol, 1,5-pentanediol, 1,6-hexanediol, neopentyl glycol, dimethylolheptane, dipropylene glycol, 2,2,4-trimethyl-1,3-pentanediol, polyethylene glycol, polypropylene glycol, and polytetramethylene glycol. Examples of the trivalent or higher aliphatic alcohol include trimethylolethane, trimethylolpropane, glycerin, and pentaerythritol. Examples of the alicyclic polyhydric alcohol include 1,4 cyclohexanediol, 1,4-cyclohexanedimethanol, spiroglycol, tricyclodecanediol, tricyclodecanedimethanol, hydrogenated bisphenol A, hydrogenated bisphenol A ethylene oxide adduct, and hydrogenated bisphenol A propylene oxide adduct. Examples of the aromatic polyhydric alcohol include bisphenol A, bisphenol A ethylene oxide adduct, bisphenol A propylene oxide adduct, p-xylene glycol, m xylene glycol, o-xylene glycol, and 1,4-phenylene glycol. Examples of other polyhydric alcohols include lactone-based polyester polyols obtained by ring-opening polymerization of lactones such as ε-caprolactone.

The third monomer is preferably at least one selected from the group consisting of an aliphatic polyhydric alcohol and an aromatic polyhydric alcohol, and the aliphatic polyhydric alcohol is preferably at least one selected from the group consisting of ethylene glycol, diethylene glycol, and pentaerythritol, and the aromatic polyhydric alcohol is preferably at least one selected from the group consisting of bisphenol A and a bisphenol A alkylene oxide adduct, and more preferably a bisphenol A propylene oxide adduct.

In order to adjust the glass transition point of the specific polyester resin to 40 degrees centigrade or higher the third monomer preferably contains ethylene glycol and a bisphenol A propylene oxide adduct. For the same reason, the third repeating unit preferably includes a repeating unit derived from ethylene glycol and a repeating unit derived from bisphenol A propylene oxide adduct.

The glass transition point of the specific polyester resin is 40 degrees centigrade or higher and 70 degrees centigrade or lower. When the specific polyester resin has such a glass transition point the composite particles are suitably plastically deformed on the recording medium when the ink containing the composite particles lands on the recording medium and is heat-treated. Since the plastically deformed composite particles spread on the surface of the recording medium, an image having high image density can be printed even when a small amount of ink is used. In order to print an image having a higher image density, the glass transition point of the specific polyester resin is preferably 50 degrees centigrade or higher and 55 degrees centigrade or lower. The method for measuring the glass transition point of the specific polyester resin is the same as or similar to the method described in Examples below. The glass transition point of the specific polyester resin can be adjusted by, for example, changing at least one of the type of monomer used when preparing the specific polyester resin and the polymerization time when preparing the specific polyester resin.

When the glass transition point of the specific polyester resin is lower than 40 degrees centigrade, the specific polyester resin may be somewhat softened in a room temperature environment. For this reason, in an image printed on a recording medium using an ink containing the composite particles, sliminess due to the specific-polyester resin occurs, and thus the tactile feeling of the recording medium on which the image is printed and the wet friction fastness of the printed image decrease.

On the other hand, when the glass transition point of the specific-polyester resin exceeds 70 degrees centigrade, the hardness of the specific polyester resin increases, and therefore, stiffness due to the specific polyester resin occurs in an image printed on a recording medium using an ink containing composite particles, and as a result, the tactile feeling (for example, resistance to swelling and stiffness) of the recording medium on which the image is printed decreases.

The acid value of the specific polyester resin is not less than 15 mgKOH/g and not more than 80 mgKOH/g. When the acid value of the specific polyester resin is within the above range, the dispersibility of the composite particles in the ink can be increased while ensuring the water resistance of an image printed using the ink. The method for measuring the acid value of the specific polyester resin is the same as or similar to the method described in Examples below

When the acid value of the specific polyester resin is less than 15 mgKOH/g, the compatibility of the specific polyester resin with an aqueous medium is reduced, and thus the dispersibility of the composite particles in the ink is reduced. As a result, in an image printed using ink, an image defect such as density unevenness is likely to occur.

On the other hand, when the acid value of the specific polyester resin exceeds 80 mgKOH/g the water resistance of the image printed using the ink decreases, and thus the wet friction fastness of the printed image decreases.

The acid value of the specific polyester resin is preferably 35 mgKOH/g or more and 70 mgKOH/g or less in order to print an image more excellent in wet friction fastness while further suppressing the occurrence of image defects.

The acid value of the specific polyester resin can be adjusted by, for example, changing the polymerization time for preparing the specific polyester resin. The acid value of the specific polyester resin can also be adjusted by using a trivalent or higher carboxylic acid (more specifically, trimellitic acid or the like) as the second monomer for forming the second repeating unit and changing the amount of the trivalent or higher carboxylic acid relative to the total amount of all monomers used.

The specific polyester resin is preferably an amorphous polyester resin, which has a glass transition point but does not have a clear melting point.

The number average molecular weight of the specific polyester resin is preferably 2500 or more and 30000 or less, more preferably 3000 or more and 30000 or less and even more preferably 3000 or more and 10000 or less. When the number average molecular weight of the specific polyester resin is 2500 or more, the strength of the ink film constituting the printed image is improved. When the number average molecular weight of the specific polyester resin is 30000 or less, the viscosity of the liquid containing the specific polyester resin does not become too high at the time of preparing the composite particles, and thus the specific polyester resin and the basic dye can be uniformly composited.

The specific polyester resin is preferably a linear polymer because it is easily complexed with the basic dye, but the specific polyester resin may be crosslinked by a crosslinking agent having a functional group that contributes to dispersion stability in the ink

### (Basic Dye Constituting Composite Particles)

The basic dye can suppress bleeding of a printed image and is excellent in water resistance of the image as compared with the direct dye and the acidic dye. As described above, the basic dye has a basic group. The basic group (for example, an amino group) becomes a cationic group (for example, —NH₄—) in an aqueous medium. Examples of the basic dye include C. I. Basic Yellow (1, 2, 3, 4, 11, 13, 14, 15, 19, 21, 28, 29, 32, 30, 40, 41, 45, 51, 03, 07, 70, and 73), C. I. Basic Orange (2, 21, 22, and 26), C. I. Basic Red (1, 2, 12, 13, 14, 15, 18, 22, 23, 24, 27, 29, 35, 36, 39, 46, 51, 69, 70, 73, and 82), C. I. Basic Violet (1, 3, 7, 10, 11, 15, 16, 20, 21, and 27), C. I. Basic Blue (1, 3, 5, 7, 9, 21, 26, 41, 45, 47, 54, 65, 69, 75, 77, 105, 117, 129, and 147), C. I. Basic Green (1 and 4) and C. I. Basic Brown 1.

The content of the basic dye is preferably 0.01% by mass or more and 10.0% by mass or less, more preferably 0.01% by mass or more and 5.0% by mass or less, and still more preferably 0.1% by mass or more and 2.5% by mass or less with respect to the mass of the ink.

### [Aqueous Medium]

The aqueous medium is a medium containing water as a main component, and may function as a solvent or a dispersion medium. Specific examples of the aqueous medium include water and mixtures of water and polar solvents, such as methanol, ethanol, isopropyl alcohol, butanol, and methyl ethyl ketone. The content of water in the aqueous medium is preferably 70% by mass or more, more preferably 80% by mass or more and even more preferably 90% by mass or more. The aqueous medium is preferably water, and more preferably ion-exchanged water.

The content of the aqueous medium is preferably 5% by mass or more and 99% by mass or less, and more preferably 50% by mass or more and 90% by mass or less with respect to the mass of the ink. When the content of the aqueous medium is within such a range an ink having an appropriate viscosity can be obtained.

### [First Additive]

The ink may further contain a first additive as necessary. The first additive is a compound capable of reacting with at least one functional group selected from the group consisting of a hydroxyl group, a carboxyl group, and an amino group by heating. The reaction by heating is caused by, for example, heat treatment after image printing. The first additive functions as, for example, a fastness improver that improves the fastness of a printed image.

Here, the specific polyester resin contained in the composite particles has a carboxyl group in addition to the sulfonic acid group. A part of the carboxyl group of the specific polyester resin is bonded to the basic dye by ionic bonding. However, a part of the carboxyl group of the specific polyester resin is not bonded to the basic dye by ionic bonding and remains in the composite particles. Hereinafter, “carboxyl group of the specific polyester resin remaining in the composite particles” may be described as “remaining carboxyl group”.

When the ink contains the first additive, the heat treatment after the printing of the image causes the following three reactions. The first reaction is a reaction between the remaining carboxyl groups of the specific polyester resin in the composite particles and the first additive. The second reaction is a reaction between the amino group of the basic dye in the composite particles and the first additive. The third reaction is a reaction between the hydroxyl group and the carboxyl group present on the surface of the recording medium and the first additive. By these reactions, the remaining carboxyl group of the specific polyester resin and the amino group of the basic dye are bonded through the first additive. In this way, the bonding between the specific polyester resin and the basic dye in one composite particle becomes strong. Also, the bonding between the specific polyester resin in one composite particle and the basic dye in the other composite particle becomes strong. Furthermore, by these reactions, the remaining carboxyl groups and amino groups in the composite particles and the hydroxyl groups and carboxyl groups present on the surface of the recording medium are bonded through the first additive. In this way, the bonding between the composite particles and the recording medium becomes strong. As a result, the degree of friction fastness (especially the degree of wet friction fastness) of the printed image can be further improved.

The heat treatment after the image printing will be described. In the case where the recording medium is a textile product, the temperature of the heat treatment is preferably 180 degrees centigrade or lower, and more preferably 100 degrees centigrade or lower, and the temperature of the heat treatment is preferably 100 degrees centigrade or higher, and more preferably 130 degrees centigrade or higher. At such a heat treatment temperature the texture of the textile product is hardly damaged. Examples of the heat treatment include a press heat treatment and a steam heat treatment. In order to improve the fastness of the printed image, the printed image may be subjected to a metal ion treatment, an acid treatment, or an alkali treatment.

Examples of the first additive include a blocked isocyanate, a polymer having an oxazoline group, a compound having an epoxy-group (for example, 1,3-bis (oxiranylmethoxy) propan-2-ol), and a polycarbodiimide. In order to print an image having more excellent wet friction fastness, the first additive is preferably at least one compound selected from the group consisting of a polymer having an oxazoline group and a polycarbodiimide, and more preferably a polymer having an oxazoline group.

The content of the first additive is preferably 0.1% by mass or more and 10.0% by mass or less and more preferably 0.1% by mass or more and 6.0% by mass or less with respect to the mass of the ink

### [Second Additive]

If necessary, the ink may further contain a second additive, which may be an ultraviolet absorber or an antioxidant, by using an ink containing the second additive, an image having excellent light resistance and heat resistance can be printed, and by including the second additive in the ink, the feel of a recording medium on which an image has been printed is improved.

Examples of the second additive include salicylate-based compounds, benzophenone-based compounds, benzotriazole-based ultraviolet absorbers (ultraviolet absorbers containing a benzotriazole structure), and hydroxyphenyltriazine-based ultraviolet absorbers (ultraviolet absorbers containing a hydroxyphenyltriazine structure). Examples of the salicylate-based compounds include phenyl salicylate, monoglycol salicylate, and t-butylphenyl salicylate. Examples of the benzophenone compound include 2-hydroxy-4-alkoxybenzophenone. Examples of the ultraviolet absorber containing a benzotriazole structure include 2(2′-hydroxy-5′-methylphenyl) benzotriazole, 2(2 hydroxy-5′-octylphenyl) benzotriazole, 2[2-hydroxy-3-(3,4,5,6-tetrahydrophthalimide methyl)-5-methylphenyl] benzotriazole, 2[2′-hydroxy-3′,5′-bis (α, α′-dimethylbenzyl) phenyl]-2H-benzotriazole, 2 (2′-hydroxy-3′, 5′-di-t-amylphenyl) benzotriazole, 2(2′-hydroxy-3′, 5′-di-t-butylphenyl) benzotriazole, 2(2′-hydroxy-3′-t-butyl-5′-methylphenyl) benzotriazole, and 2(2′-hydroxy-3′-t-butyl-5′-methylphenyl)-5-chlorobenzotriazole. Examples of ultraviolet absorbers containing a hydroxyphenyltriazine structure include 2,4,6-tris (2-hydroxy 4-hexyloxy-3-methylphenyl)-1,3,5-triazine and 2,4-diphenyl-6-(2-hydroxy-4-hexyloxyphenyl)-1,3,5-triazine. As a second additive other than the above, resorcinol monobenzoate, 2′-ethylhexyl-2-cyano-3-phenylcinnamate, or bis (2,2,6,6-tetramethyl-4-piperidine) sebacate can also be used.

The second additive is preferably an ultraviolet absorber containing a benzotriazole structure or an ultraviolet absorber containing a hydroxyphenyl triazine structure. The content of the second additive is preferably 0.1% by mass or more and 10.0% by mass or less, and more preferably 0.1% by mass or more and 6.0% by mass or less, with respect to the mass of the ink.

### [Surfactant]

The ink may further contain a surfactant as necessary. When ink contains a surfactant, an ink having excellent wettability with respect to a recording medium can be obtained. Examples of the surfactant include an anionic surfactant, a cationic surfactant, a nonionic surfactant and an amphoteric surfactant. The ink may contain only one type of surfactant, or may contain two or more types of surfactants.

As the surfactant, a nonionic surfactant is preferable. When the ink contains a nonionic surfactant, it is possible to obtain an ink having excellent dispersion stability of composite particles.

The content of the surfactant is preferably 0.01% by mass or more and 0.50% by mass or less with respect to the mass of the ink. When the content of the surfactant is in such a range, an ink having excellent dispersion stability of the composite particles is obtained, and when the content of the surfactant is 0.50% by mass or less, bubbles are hardly generated from the ink in the nozzle of the recording head included in the inkjet recording apparatus, and the ink can be stably ejected from the nozzle. When two or more surfactants are contained in the ink, the content of the surfactant means the total content of the two or more surfactants.

### [Humectant]

The ink may contain a humectant as necessary, and when the ink contains a humectant, volatilization of a liquid component from the ink can be suppressed. Examples of the humectant include polyalkylene glycols, alkylene glycols, and glycerin. Examples of the polyalkylene glycols include polyethylene glycol and polypropylene glycol. Examples of alkylene glycols include 3-methyl-1,5-pentanediol, ethylene glycol, propylene glycol, butylene glycol, diethylene glycol, di propylene glycol, trimethylene glycol (i.e., 1,3-propanediol), triethylene glycol, tripropylene glycol, 1,2,6-hexanetriol, thiodiglycol, 1,3-butanediol, and 1,5-pentanediol. The humectant is preferably at least one of alkylene glycols and glycerin, and more preferably at least one of propylene glycol and glycerin. The content of the humectant is preferably 0.1% by mass or more and 10.0% by mass or less and more preferably 0.1% by mass or more and 5.0% by mass or less with respect to the mass of the ink.

### [Other Components]

The ink may further contain components other than the components described above (more specifically, a viscosity modifier, a dissolution stabilizer, a penetrant, and the like) as necessary. However, in order to print an image having more excellent wet friction fastness, it is preferable that the ink does not contain a pigment. Before printing an image on a recording medium using ink, the recording medium may be subjected to pretreatment. By performing the pretreatment, bleeding of an image to be printed is suppressed, and an image having high color developability and high definition can be printed.

### [Preferred Combinations of Materials]

In order to print an image further excellent in wet friction fastness while further suppressing the occurrence of image defects, it is preferable to satisfy the following condition 1, it is more preferable to satisfy the following condition 2, and it is still more preferable to satisfy the following condition 3.

Condition 1: The ink contains a polymer having an oxazoline group as the first additive, and the acid value of the specific polyester resin is 35 mgKOH/g or more and 70 mgKOH/g or less.
Condition 2: Condition 1 is satisfied, and the first repeating unit ratio of the specific polyester resin is 3.0 mol % or more and 3.5 mol % or less.
Condition 3: Condition 2 is satisfied, and the glass transition point of the specific polyester resin is 50 degrees centigrade or higher and 55 degrees centigrade or lower.

### <Ink Manufacturing Method>

Next, a preferred method for producing the ink according to the embodiment described above will be described. The preferred method for producing the ink includes, for example, a polyester resin preparation step, a composite particle preparation step, and a mixing step.

### [Polyester Resin Preparation Step]

In the polyester resin preparation step, the specific polyester resin is prepared. Specifically, in the polyester resin preparation step, the specific polyester resin is obtained by condensation polymerization of the first monomer, the second monomer, and the third monomer.

The amount of the first monomer used in the polyester resin preparation step (the amount of the first monomer used in the synthesis reaction of the specific polyester resin) is, as a molar ratio relative to the total amount of the first monomer and the second monomer used, 1.5 mol % or more and 10.0 mol % or less. Hereinafter, the “amount of the first monomer used (molar ratio) relative to the total amount of the first monomer and the second monomer used” may be referred to as “first monomer ratio”. When the first monomer ratio is within such a range, the first repeating unit ratio can be adjusted to 1.5 mol % or more and 10.0 mol % or less. In order to obtain an ink capable of printing an image more excellent in wet friction fastness while suppressing the occurrence of an image defect, and capable of suppressing the deterioration of the touch feeling of a recording medium on which the image is printed, the first monomer ratio is preferably 1.5 mol % or more and 8.0 mol % or less, more preferably 1.0 mol % or more and 7.2 mol % or less, and still more preferably 3.0 mol % or more and 3.5 mol % or less.

The amount of the first monomer used in the polyester resin preparation step is preferably 3% by mass or more and 15% by mass or less, more preferably 3% by mass or more and 11% by mass or less, as a mass ratio with respect to the total amount of the first monomer and the second monomer used. The glass transition point of the specific polyester resin obtained in the polyester resin preparation step is 40 degrees centigrade or higher and 70 degrees centigrade or lower. The acid value of the specific polyester resin obtained in the polyester resin preparation step is 15 mgKOH/g or more and 80 mgKOH/g or lower.

The condensation polymerization can be performed by a known method, examples of which include a vacuum polymerization method, a reduced-pressure polymerization method, and an acid chloride method. In the reduced pressure polymerization method, a specific polyester resin having a low molecular weight is easily obtained as compared with the vacuum polymerization method.

An example of a condensation polymerization method will be described below. The first monomer, the second monomer, and the third monomer are stirred in the presence of a catalyst while reducing the pressure to a predetermined level. In this manner, the first monomer, the second monomer, and the third monomer are condensation-polymerized. Examples of the catalyst include zinc acetate and antimony trioxide. The predetermined pressure is preferably not less than 1 mmHg and not more than 10 mmHg. The condensation polymerization temperature is preferably 130 degrees centigrade or higher and 270 degrees centigrade or lower. The condensation polymerization time is preferably 20 minutes or longer and 500 minutes or longer, and more preferably 30 minutes or longer and 300 minutes or shorter.

### [Composite Particle Preparation Step]

In the composite particle preparation step, composite particles which are particles of a composite of the specific polyester resin and the basic dye are prepared. The amount of the specific polyester resin used in the composite particle preparation step (the amount of the specific polyester resin used in the preparation of the composite particles) is 1.0 or more and 10.0 or less as a mass ratio to the amount of the basic dye used (the amount of the basic dye used in the preparation of the composite particles). By using the specific polyester resin at such a mass ratio, the resin/dye ratio can be adjusted to 1.0 or more and 10.0 or less.

Next, the specific polyester resin and the basic dye are mixed to obtain composite particles. An example of a method for preparing composite particles will be described. First, the specific polyester resin is dissolved in an aqueous medium to obtain a solution of the specific polyester resin. Also, a basic dye is dissolved in an aqueous medium to obtain a basic dye solution. By mixing the obtained specific polyester resin solution and the basic dye solution, the specific polyester resin and the basic dye are complexed and composite particles are prepared. When mixing the specific polyester resin solution and the basic dye solution it is preferable to mix the solutions by dropping the basic dye solution in the specific polyester resin solution. The temperature at the time of mixing is preferably 40 degrees centigrade or more and 00 degrees centigrade or less. The stirring speed at the time of mixing is preferably 100 rpm or more and 500 rpm or less, more preferably 200 rpm or more and 400 rpm or less. The mixing time is preferably 5 minutes or longer and 80 minutes or shorter.

The amount of the basic dye introduced into the specific polyester resin can be confirmed by the following method. That is, after the basic dye solution and the specific polyester resin solution are mixed to form composite particles, the liquid containing the composite particles is collected. A centrifuge is used to centrifuge the liquid at a rotation rate of 15000 rpm for 30 minutes. After centrifugation, the supernatant is collected. A spectrophotometer is used to determine the amount of basic dye contained in the supernatant by spectrophotometry. The amount of basic dye contained in the supernatant corresponds to the amount of basic dye not introduced into the specific polyester resin. Then, a value obtained by subtracting the amount of the basic dye not introduced into the specific polyester resin from the total amount of the basic dye used is calculated, and the amount of the basic dye introduced into the specific polyester resin is obtained.

Another example of the method for preparing the composite particles will be described. First, the specific polyester resin and the basic dye are heated and dissolved in an aqueous medium to obtain a solution, and the obtained solution is sprayed onto a water layer. When the sprayed solution reaches the surface of the water, composite particles are formed.

Still another example of the method for preparing the composite particles will be described. First, a specific polyester resin is dissolved in an aqueous medium to obtain a specific polyester resin solution, a basic dye is dissolved in an aqueous medium to obtain a basic dye solution, and the pH of the basic dye solution is adjusted to about A. By adding the basic dye solution whose pH is adjusted to about A to the obtained specific polyester resin solution, the specific polyester resin and the basic dye are complexed to prepare composite particles.

After the composite particles are obtained in the composite particle preparation step, the composite particles are preferably washed with water (for example, ion-exchanged water) until the predetermined conductivity of the composite particles becomes 30 μS/cm or less. Examples of the washing treatment of the composite particles include a washing treatment in which the composite particles are dispersed in water (for example, ion exchanged water), and then the composite particles are collected by filtration. The more times the washing process is performed, the lower the predetermined conductivity of the composite particles becomes.

### [Mixing Step]

In the mixing step, the aqueous medium and the composite particles are mixed with each other. For example, a stirrer is used for mixing. Furthermore, optional components added as needed (more specifically at least one component selected from the group consisting of a first additive, a second additive, a surfactant, a humectant, and other components) may be further added and mixed. The resulting mixture is filtered if necessary. As a result, an ink according to the above embodiment (an ink capable of printing an image having an excellent degree of wet friction fastness while suppressing the occurrence of image defects, and also capable of suppressing a decrease in the touch feeling of the recording medium on which the image is printed) is produced. The preferred method for producing the ink according to the present embodiment, has been described.

### Examples

Examples of the present disclosure will be described below, but the present disclosure is not limited to the scope of examples. First, a method for measuring the glass transition point of a polyester resin, a method for measuring the acid value of a polyester resin, and a method for measuring the number average molecular weight of a polyester resin will be described.

### <Measurement Method of Glass Transition Point>

The glass transition temperature (hereinafter sometimes referred to as Tg) of each of the polyester resins A to M described below was measured using a differential scanning calorimeter (“DSC-6220” manufactured by Seiko Instruments Co., Ltd.) according to JIS (Japan Industrial Standard) K7121-2012.

### <Method for Measuring Acid Value>

0.2 g of a sample (any of the polyester resins A to M described below) was precisely weighed in a glass stoppered Erlenmeyer flask, and 20 mL of benzyl alcohol was put in the flask. Then, the contents of the flask were heated for 15 minutes by a heater set at a temperature of 230 degrees centigrade while keeping the atmosphere of nitrogen in the flask. Then, the contents of the flask were cooled to a temperature of 25 degrees centigrade, and 20 mL of chloroform and a few drops of an ethanol solution of cresol red (indicator) were added to the flask. The contents of the flask were then titrated with an ethanol solution of potassium hydroxide (concentration 0.02 mol/L), where the resulting liter was designated B (unit: mL).

In addition, separately, as a blank test, the same operation as described above was performed except that the polyester resin was not used. The titer from this blank test is designated C (unit: mL).

The acid value (unit: mgKOH/g) of the polyester resins was calculated from the following formula. In the following formula, p is the potency of the ethanol solution of potassium hydroxide used (concentration: 0.02 mol/L).

Acid value=(B−C)×0.02×56.11×p/0.2

### <Method for Measuring Number Average Molecular Weight>

The number average molecular weight of each of the polyester resins A to M described below was measured using gel permeation chromatography (GPC). The preparation conditions of the measurement sample and the GPC measurement conditions were as follows.

### [Conditions for Preparing Measurement Sample]

Eluent: THF (tetrahydrofuran)
Solution concentration: 3.0 mg/mL
Pretreatment filtration through a filter having a pore size of 0.45 μm
Injection volume: 100 μL

### [CPC Measurement Conditions]

Apparatus: HLC-8220GPC (manufactured by Tosoh Corporation)

Column: TSKgel GMHXL-L (manufactured by Tosoh Corporation)
Number of columns: 2 (series connection)
Column temperature: 40 degrees centigrade
Carrier solvent: THF (tetrahydrofuran)
Carrier flow rate: 1 mL/min
Detector: RI (refractive index) detector
Calibration curve: calibration curve prepared using standard polystyrene

### <Polyester Resin Preparation Step>

Next, preparation steps of polyester resins A to M (hereinafter, each may be referred to as resins A to M) will be described.

### [Preparation of Resin A]

A four-neck flask equipped with a fractionating column, a nitrogen introduction tube, a thermometer, and a stirrer was prepared, and terephthalic acid (mass: 50 g), 5-sodium sulfoisophthalic acid (mass: 3 g), ethylene glycol (mass: 30 g), bisphenol A propylene oxide 2 mol adduct (mass: 70 g), and zinc acetate (mass: 0.1 g) as a catalyst were added to the flask. Then, the flask contents were heated to 170 degrees centigrade. The temperature of the contents of the flask was raised from 130 degrees centigrade to 170 degrees centigrade over 2 hours. Next, isophthalic acid (mass: 47 g) and antimony trioxide (mass: 0.1 g) were added to the flask, and the temperature of the flask contents was raised from 170 degrees centigrade to 200 degrees centigrade over 2 hours. Next, while gradually raising the temperature of the contents of the flask from 200 degrees centigrade to 250 degrees centigrade, the pressure in the flask was gradually reduced from the normal pressure to 5 mm Mg. The flask contents were subjected to condensation polymerization reaction under conditions of a temperature of 250 degrees centigrade and a pressure of 5 mmHg until the number average molecular weight of the polymer contained in the flask contents became 5200, to obtain resin A. The obtained resin A was confirmed to be an amorphous polyester resin without having a clear melting point.

### [Preparation of Resins B to M]

Each of resins B to M was obtained in the same manner as in the preparation of resin A except that the types and masses of the monomers were as shown in Tables 1 to 3, and the flask contents were subjected to condensation polymerization reaction until the number average molecular weights of the polymers contained in the flask contents became the values shown in Tables 1 to 3. In the preparation of each of resins B to M, a monomer other than isophthalic acid was placed in a flask in the same procedure as in the preparation of resin A. After the flask contents were heated, isophthalic acid was added to the flask, and the flask contents were subjected to condensation polymerization reaction. None of the obtained resins B to M had a clear melting point, and it was confirmed that they were amorphous polyester resins.

TABLE 1

| | | | Resin A | Resin B | Resin C | Resin D |
|---|---|---|---|---|---|---|
| First | 5-sodium sulfoisophthalic | Mass [g] | 3 | 11 | 5 | 5 |
| monomer | acid | Material | 0.11 | 0.041 | 0.019 | 0.019 |
| | | amount [mol] | | | | |
| | 4-sulfophthalic acid | Mass [g] | 0 | 0 | 0 | 0 |
| | | Material | 0 | 0 | 0 | 0 |
| | | amount [mol] | | | | |
| Second | Terephthalic acid | Mass [g] | 50 | 50 | 50 | 50 |
| monomer | | Material | 0.301 | 0.301 | 0.301 | 0.301 |
| | | amount [mol] | | | | |
| | Isophthalic acid | Mass [g] | 47 | 34 | 43 | 31 |
| | | Material | 0.283 | 0.205 | 0.259 | 0.187 |
| | | amount [mol] | | | | |
| | Naphthalenedicarboxylic | Mass [g] | 0 | 5 | 0 | 7 |
| | acid | Material | 0 | 0.023 | 0 | 0.032 |
| | | amount [mol] | | | | |
| | Trimellitic acid | Mass [g] | 0 | 0 | 2 | 7 |
| | | Material | 0 | 0 | 0.01 | 0.033 |
| | | amount [mol] | | | | |
| Third | Ethylene glycol | Mass [g] | 30 | 28 | 25 | 25 |
| monomer | | Material | 0.484 | 0.452 | 0.403 | 0.403 |
| | | amount [mol] | | | | |
| | Bisphenol A PO adduct | Mass [g] | 70 | 72 | 75 | 75 |
| | | Material | 0.203 | 0.209 | 0.218 | 0.218 |
| | | amount [mol] | | | | |
| | Diethlene glycol | Mass [g] | 0 | 0 | 0 | 0 |
| | | Material | 0 | 0 | 0 | 0 |
| | | amount [mol] | | | | |
| | Pentaerythritol | Mass [g] | 0 | 0 | 0 | 0 |
| | | Material | 0 | 0 | 0 | 0 |
| | | amount [mol] | | | | |

| | | | | |
|---|---|---|---|---|
| First monomer ratio | 1.9 | 7.2 | 3.2 | 3.3 |
| (First repeating unit ratio) [mol %] | | | | |
| Number average molecular weight | 5200 | 6500 | 4000 | 3000 |
| Acid value [mgKOH/g] | 16 | 18 | 35 | 70 |
| Tg [degrees centigrade] | 42 | 50 | 50 | 55 |

TABLE 2

| | | | Resin E | Resin F | Resin G | Resin H |
|---|---|---|---|---|---|---|
| First | 5-sodium sulfoisophthalic | Mass [g] | 8 | 0 | 0 | 20 |
| monomer | acid | Material | 0.03 | 0 | 0 | 0.075 |
| | | amount [mol] | | | | |
| | 4-sulfophthalic acid | Mass [g] | 0 | 4 | 0 | 0 |
| | | Material | 0 | 0.16 | 0 | 0 |
| | | amount [mol] | | | | |
| Second | Terephthalic acid | Mass [g] | 40 | 50 | 50 | 35 |
| monomer | | Material | 0.241 | 0.301 | 0.301 | 0.211 |
| | | amount [mol] | | | | |
| | Isophthalic acid | Mass [g] | 35 | 46 | 50 | 31 |
| | | Material | 0.211 | 0.277 | 0.301 | 0.187 |
| | | amount [mol] | | | | |
| | Naphthalenedicarboxylic | Mass [g] | 15 | 0 | 0 | 10 |
| | acid | Material | 0.069 | 0 | 0 | 0.046 |
| | | amount [mol] | | | | |
| | Trimellitic acid | Mass [g] | 2 | 0 | 0 | 3 |
| | | Material | 0.01 | 0 | 0 | 0.014 |
| | | amount [mol] | | | | |
| Third | Ethylene glycol | Mass [g] | 15 | 25 | 30 | 17 |
| monomer | | Material | 0.242 | 0.403 | 0.484 | 0.274 |
| | | amount [mol] | | | | |
| | Bisphenol A PO adduct | Mass [g] | 75 | 73 | 70 | 75 |
| | | Material | 0.218 | 0.212 | 0.203 | 0.218 |
| | | amount [mol] | | | | |
| | Diethlene glycol | Mass [g] | 5 | 2 | 0 | 5 |
| | | Material | 0.047 | 0.019 | 0 | 0.047 |
| | | amount [mol] | | | | |
| | Pentaerythritol | Mass [g] | 5 | 0 | 0 | 3 |
| | | Material | 0.037 | 0 | 0 | 0.22 |
| | | amount [mol] | | | | |

| | | | | |
|---|---|---|---|---|
| First monomer ratio | 5.3 | 2.7 | 0 | 14 |
| (First repeating unit ratio) [mol %] | | | | |
| Number average molecular weight | 8000 | 5100 | 5000 | 9000 |
| Acid value [mgKOH/g] | 20 | 16 | 15 | 21 |
| Tg [degrees centigrade] | 65 | 43 | 48 | 65 |

TABLE 3

| | | | Resin I | Resin J | Resin K | Resin L | Resin M |
|---|---|---|---|---|---|---|---|
| First | 5-sodium sulfoisophthalic | Mass [g] | 3 | 5 | 3 | 3 | 3 |
| monomer | acid | Material | 0.011 | 0.011 | 0.011 | 0.011 | 0.011 |
| | | amount [mol] | | | | | |
| | 4-sulfophthalic acid | Mass [g] | 0 | 0 | 0 | 0 | 0 |
| | | Material | 0 | 0 | 0 | 0 | 0 |
| | | amount [mol] | | | | | |
| Second | Terephthalic acid | Mass [g] | 50 | 45 | 48 | 40 | 47 |
| monomer | | Material | 0.301 | 0.271 | 0.289 | 0.241 | 0.283 |
| | | amount [mol] | | | | | |
| | Isophthalic acid | Mass [g] | 47 | 55 | 47 | 32 | 50 |
| | | Material | 0.283 | 0.211 | 0.283 | 0.193 | 0.301 |
| | | amount [mol] | | | | | |
| | Naphthalenedicarboxylic | Mass [g] | 0 | 5 | 0 | 20 | 0 |
| | acid | Material | 0 | 0.023 | 0 | 0.093 | 0 |
| | | amount [mol] | | | | | |
| | Trimellitic acid | Mass [g] | 0 | 12 | 2 | 5 | 0 |
| | | Material | 0 | 0.057 | 0.01 | 0.024 | 0 |
| | | amount [mol] | | | | | |
| Third | Ethylene glycol | Mass [g] | 35 | 25 | 50 | 10 | 25 |
| monomer | | Material | 0.565 | 0.403 | 0.806 | 0.161 | 0.405 |
| | | amount [mol] | | | | | |
| | Bisphenol A PO adduct | Mass [g] | 65 | 75 | 50 | 75 | 75 |
| | | Material | 0.189 | 0.216 | 0.145 | 0.218 | 0.218 |
| | | amount [mol] | | | | | |
| | Diethlene glycol | Mass [g] | 0 | 0 | 0 | 0 | 0 |
| | | Material | 0 | 0 | 0 | 0 | 0 |
| | | amount [mol] | | | | | |
| | Pentaerythritol | Mass [g] | 0 | 0 | 0 | 15 | 0 |
| | | Material | 0 | 0 | 0 | 0.11 | 0 |
| | | amount [mol] | | | | | |

| | | | | | |
|---|---|---|---|---|---|
| First monomer ratio | 1.9 | 2 | 1.9 | 2 | 1.9 |
| (First repeating unit ratio) [mol %] | | | | | |
| Number average molecular weight | 15000 | 3000 | 9000 | 35000 | 8500 |
| Acid value [mgKOH/g] | 5 | 85 | 15 | 16 | 9 |
| Tg [degrees centigrade] | 42 | 43 | 38 | 75 | 43 |

The meaning of each term in Tables 1 to 3 is as follows, “bisphenol A PO adduct” means bisphenol A propylene oxide 2 mol adduct.

The “first monomer ratio” means a use amount (molar ratio) of the first monomer with respect to a total use amount of the first monomer and the second monomer. The first monomer ratio was calculated from the formula “first monomer ratio=100×[(amount of substance of 5-sodium sulfoisophthalic acid)+(amount of substance of 4-sulfophthalic acid)]/[(amount of substance of 5-sodium sulfoisophthalic acid)+(amount of substance of 4-sulfophthalic acid)+(amount of substance of terephthalic acid)+(amount of substance of isophthalic acid) (amount of substance of naphthalenedicarboxylic acid)+(amount of substance of trimellitic acid)]”.

It was confirmed by analysis using NMR that the amount of substance of the first monomer and the amount of substance of the second monomer before the condensation polymerization reaction were the same as the amount of substance of the corresponding repeating unit after the condensation polymerization reaction. Thus, the “first monomer ratio” corresponds to the “first repeating unit ratio”. The meaning of each term in Tables 1 to 6 has been described above

### <Composite Particle Preparation Step>

Using the resins A to M obtained by the above-described procedure, composite particles C1 to C16 were prepared by the preparation method described later. Details of the composite particles C1 to C16 are shown in Table 4. As described later, the composite particles C9 and 016 were attempted to be prepared, but the composite particles C9 and C10 as shown in Table 4 could not be prepared.

TABLE 4

| | Resin | | Dye | | | Con- |
|---|---|---|---|---|---|---|
| | | Amount | | Amount | | ductivity |
| Compound | | [parts by | | [parts by | Resin/ | [unit: |
| particle | Type | mass] | Type | mass] | dye | [μS/cm] |
| C1 | A | 15 | B.Y. 28 | 2 | 7.5 | 13 |
| C2 | B | 10 | B.Y. 28 | 2 | 5 | 10 |
| C3 | C | 5 | B.Y. 28 | 2 | 2.5 | 6 |
| C4 | D | 15 | B.Y. 41 | 2 | 7.5 | 12 |
| C5 | E | 10 | B.Y. 41 | 2 | 5 | 8 |
| C6 | F | 15 | B.Y. 41 | 2 | 7.5 | 12 |
| C7 | A | 15 | B.Y. 29 | 2 | 7.5 | 11 |
| C8 | A | 32 | B.Y. 28 | 2 | 16 | 21 |
| C9 | G | 15 | B.Y. 28 | 2 | 7.5 | — |
| C10 | H | 15 | B.Y. 29 | 2 | 7.5 | 15 |
| C11 | I | 15 | B.Y. 28 | 2 | 7.5 | 11 |
| C12 | J | 15 | B.Y. 41 | 2 | 7.5 | 8 |
| C13 | K | 15 | B.Y. 29 | 2 | 7.5 | 13 |
| C14 | L | 15 | B.Y. 41 | 2 | 7.5 | 7 |
| C15 | M | 15 | B.Y. 28 | 2 | 7.5 | 13 |
| C16 | A | 1 | B.Y. 29 | 2 | 0.5 | — |

The meaning of each term in Table 4 will be described below. “B. Y. 28”. “B. B. 41”, and “B. R. 29” are as shown below, and all are basic-dyes.

B. Y. 28: C. I. basic yellow 28
B. B. 41: C. I. basic blue 41

### B. R. 29: C. I. Basic Red 29

“Resin/dye” means the mass ratio of polyester resin to dye. “Conductivity” means a predetermined conductivity (unit: μS/cm). A method for measuring the predetermined conductivity will be described in [Method for measuring predetermined conductivity] described later. Here, “-” in the column of conductivity means that the predetermined conductivity could not be measured because the composite particles could not be prepared. The meaning of each term in Table 4 has been described above.

### [Preparation of Composite Particles C1]

Resin A (amount: 15 parts by mass) and ion-exchanged water (amount: 200 parts by mass) were put into a three-neck flask, and the contents of the flask were stirred at a temperature of 80 degrees centigrade and a stirring speed of 300 rpm for 30 minutes to dissolve the resin A in the ion-exchanged water. Thus, an aqueous solution SI of the resin A was obtained.

In another three-neck flask C. I. Basic Yellow 28 (amount 2 parts by mass) which was a basic dye, ion-exchanged water (amount 150 parts by mass), and 10% aqueous acetic acid solution (amount: 0.1 parts by mass) were charged, and the contents of the flask were stirred at a temperature of 05 degrees centigrade and a stirring speed of 300 rpm for 30 minutes to obtain an aqueous solution S2 of a basic dye.

Next, while stirring the aqueous solution SI of the polymer A (temperature: 80 degrees centigrade), the aqueous solution S2 of the basic dye (temperature: Go degrees centigrade) was added dropwise to the aqueous solution S1. The stirring speed of the aqueous solution S1 at the time of the addition was 300 rpm, and the drip rate of the aqueous solution S2 was 0.15 L/hour. After the completion of the addition, the contents of the flask were stirred for GO minutes. Thus, a dispersion liquid of the composite particles C1 which are composite particles of the polymer A and the C. I. basic yellow 28 was obtained, and then the wet cake-like composite particles C1 were collected from the dispersion liquid by filtration using a Buechner funnel.

Next, the wet cake like composite particles C1 were washed. More specifically, washing treatment, in which after the wet cake-like composite particles C1 were re dispersed in ion exchanged water, the wet cake-like composite particles C1 were collected by filtration using a Buechner funnel was done. Then, the washing treatment was repeated until the predetermined conductivity of the composite particles C1 measured by the [Method for measuring predetermined conductivity] described later became the value shown in Table A.

After the washing treatment, the wet cake tike composite particles C1 were dried using a continuous surface reforming apparatus (“Coatmizer (registered trademark)” manufactured by Freund Corporation) under the drying conditions of a hot air temperature of 45 degrees centigrade and a blower air volume of 2 m³/min. Thus, composite particles C1 were obtained.

[[Preparation of complex particles C2 to C8 and C10 to C15]

Each of the composite particles C2 to C8 and C10 to C15 was prepared in the same manner as the preparation of the composite particles C1, except that the type of resin, the amount of resin, the type of basic dye, and the amount of basic dye were set as shown in Table 4, and the washing treatment was repeated so that the predetermined conductivity became the value shown in Table 4.

### [Attempt to Prepare Composite Particles C9]

Except that the resin A was changed to the resin G, the preparation of the composite particles C9 was attempted in the same manner as the preparation of the composite particles C1. However, since the resin G was not dissolved in the ion-exchanged water, the composite particles C9 could not be uniformly formed, and the composite particles C9 could not be prepared. For this reason, the preparation work of the <Preparation of dispersion liquid of composite partieles> described below was not carried out for the composite particles C9.

### [Attempts to Prepare Composite Particles C16]

Composite particles C16 were prepared in the same manner as the preparation of the composite particles C1, except that the resin A (amount: 15 parts by mass) was changed to the resin A (amount 1 part by mass), that is, the resin/dye ratio was changed to 0.5. However, although the shape of the composite particles was formed, a part of the basic dye was not, introduced into the composite particles and remained in the aqueous solution. Therefore, the composite particles C16 having the resin/dye ratio of 0.5 could not be prepared. Therefore, the preparation work starting with the <Preparation of dispersion liquid of composite partieles> described below was not carried out for the composite particles C16.

### [Method for Measuring Predetermined Conductivity]

The predetermined conductivity of each of the composite particles was measured in the following manner. The predetermined conductivity was measured in an environment of a temperature of 25 degrees centigrade and a humidity of 60% RH. First, the wet cake-like composite particles were diluted with ion-exchanged water so that the solid content concentration was 5% by mass (that is, the composite particle concentration was 5% by mass), thereby measurement solution was obtained. Next, the measurement solution was subjected to dispersion treatment for 5 minutes using an ultrasonic dispersion machine (“Ultrasonic Mini Welder P128” manufactured by Ultrasonic Engineering Co., Ltd.). After the dispersion treatment, the conductivity of the measurement solution was measured using a portable conductivity meter (“D-74” manufactured by HORIBA, Ltd.).

### Preparation of Dispersion Liquid of Composite Partieles>

10 parts by mass of composite particles (specifically, any of C1 to C8 and C10 to C15), 70 parts by mass of methyl ethyl ketone, and 10 parts by mass of 2-pyrrolidone were put into a three-neck flask, and the contents of the flask were stirred for 30 minutes under the condition that the internal temperature of the flask was 60 degrees centigrade. Then, 10 parts by mass of an aqueous solution of diisopropylamine (concentration 10% by mass) was put into the flask. Then, 180 parts by mass of ion-exchanged water was dripped into the flask at a drip rate of 0.3 L/hour. After the dripping was finished, the contents of the flask were stirred for 2 hours under the condition that the internal temperature of the flask was 60 degrees centigrade. After the stirring, the liquid in the flask was cooled and the liquid was taken out. The liquid removed from the flask was distilled under reduced pressure for 30 minutes at a temperature of 53 degrees centigrade using an evaporator, and methyl ethyl ketone was removed from the liquid. In this way, a dispersion liquid of composite particles was obtained.

### <Preparation of Ink: Mixing Step of Mixing Aqueous Medium and Composite Particles>

Inks (I-A1) to (I-A14) and (I-B1) to (I-B7) were prepared using the dispersion liquid of the composite particles obtained in the above-described procedure by a preparation method described later. The compositions of each of the inks (I-A1) to (I-A14) and (I-B1) to (I-B7) are shown in Table 5. Although the compositions of the ink (I-A1) and the ink (I-A4) are the same as each other, but since the presence or absence of the cloth pretreatment, in the <evaluation method> described below is different, the ink numbers different from each other are given for convenience of description

TABLE 5

| | | | | | Presence or |
|---|---|---|---|---|---|
| | | | Additive | | absence |
| | | Composite | | Mass | of cloth |
| | Ink | particle | Type | [g] | pretreatment |
| Example 1 | I-A1 | C1 | — | — | NO |
| Example 2 | I-A2 | C1 | ADD-1 | 0.05 | NO |
| Example 3 | I-A3 | C2 | ADD-2 | 0.05 | NO |
| Example 4 | I-A4 | C1 | — | — | YES |
| Example 5 | I-A5 | C1 | ADD-3 | 0.1 | NO |
| Example 6 | I-A6 | C3 | — | — | NO |
| Example 7 | I-A7 | C3 | ADD-4 | 0.15 | NO |
| Example 8 | I-A8 | C3 | ADD-4 | 0.3 | NO |
| Example 9 | I-A9 | C4 | ADD-5 | 0.2 | NO |
| Example 10 | I-A10 | C5 | ADD-6 | 0.15 | NO |
| Example 11 | I-A11 | C1 | ADD-6 | 0.3 | NO |
| Example 12 | I-A12 | C6 | — | — | NO |
| Example 13 | I-A13 | C7 | — | — | NO |
| Example 14 | I-A14 | C1 | ADD-7 | 0.1 | NO |
| Comparison | I-B1 | C8 | — | — | NO |
| example 1 | | | | | |
| Comparison | I-B2 | C10 | — | — | NO |
| example 2 | | | | | |
| Comparison | I-B3 | C11 | — | — | NO |
| example 3 | | | | | |
| Comparison | I-B4 | C12 | — | — | NO |
| example 4 | | | | | |
| Comparison | I-B5 | C13 | — | — | NO |
| example 5 | | | | | |
| Comparison | I-B6 | C14 | — | — | NO |
| example 6 | | | | | |
| Comparison | I-B7 | C15 | — | — | NO |
| example 7 | | | | | |

Hereinafter, the meanings of the terms in Table 5 will be described, means that the corresponding component was not used. “YES” in “Presence or absence of cloth pretreatment” means that the pretreatment described in [Cloth pretreatment] described later was performed, and “NO” means that the pretreatment was not performed.

The details of the additives shown in Table 5 are as follows. ADD-1: an ultraviolet absorber containing a benzotriazole structure. “Tinuvin (registered trademark) 9945-DW” manufactured by BASF, active ingredient concentration of 45% by mass ADD-2: An ultraviolet absorber containing a hydroxyphenyl triazine structure, “Tinuvin (registered trademarks 477-DW” manufactured by BASF active ingredient concentration of 20% by mass

ADD-3: Blocked isocyanate, “Meikanate CX” manufactured by Meisei Chemical Industry Co., Ltd.
ADD-4: Polymer having an oxazoline group. “EPOCROS (registered trademark) K-2020E” manufactured by Nippon Shokubai Co., Ltd., active ingredient concentration of 40% by mass
ADD-5: Polymer having an oxazoline group, “EPOCROS (registered trademark) WS-500” manufactured by Nippon Shokubai Co., Ltd., active ingredient concentration 39% by mass
ADD-6: Polycarbodiimide, “V-02” manufactured by Nisshinbo Chemical Industries, Inc., active ingredient concentration of 40% by mass
ADD-7: 1,3-Bis (oxiranylmethoxy) propane-2-ol. “Denacol (registered trademark) EX-313” manufactured by Nagase Chemtex Corporation
The meanings of the terms in Table 5 have been described above.

### [Preparation of Ink (I-A1)]

A dispersion liquid (mass: 5 g) of the composite particles C1 obtained by the procedure shown in the above <Preparation of dispersion liquid of composite particles>, glycerin (mass: 0.044 g), propylene glycol (mass: 0.044 g), a nonionic surfactant (“SURFYNOL (registered trademark) 440” manufactured by Nissin Chemical Industry Co., Ltd., acetylene glycol ethylene oxide adduct, HLB value: 8) (mass 0.028 g), and ion-exchanged water (mass 0.439 g) were stirred at a temperature of 20 degrees centigrade for 16 minutes using a stirrer to obtain a liquid. Next the obtained liquid was filtered using a membrane filter (average pore size: 1.0 μm) to obtain an ink (I-A1).

### [Preparation of Ink (I-A4)]

As described above, since the ink (I-A1) and the ink (I-A4) have the same composition, a part of the obtained ink (I-A1) was prepared as the ink (I-A4).

### [Preparation of Inks (I-A6), (I-A12), (I-A13) and (I-B1) to (I-B7)]

Each of the inks (I-A6), (I-A12), (I-A13), and (I-B1) to (I-B7) was obtained in the same manner as the preparation of the ink (I-A1), except that a dispersion liquid of composite particles of the type shown in Table 5 was used.

### [Preparation of Inks (I-A2), (I-A3), (I-A5), (I-A7) to (I-A11) and (I-A14)]

Each of inks (I-A2), (I-A3), (I-A5), (I-A7) to (I-A11) and (I-A14) was obtained in the same manner as the preparation of ink (I-A1), except that a dispersion liquid of composite particles of the type shown in Table 5 was used and additives of the type and mass shown in Table 5 were further added when stirring with a stirrer.

### <Evaluation Method>

Each of the inks (I-A1) to (I-A14) and (I-B1) to (I-B7) to be evaluated was used to print an image on a cloth, and the printed image was evaluated. Specifically, each of the inks (I-A1) to (I-A14) and (I-B1) to (I-B7) was used to perform printing on the cloth by an inkjet recording apparatus and heat treatment on the cloth after printing, as described below. For the ink (I-A4), pretreatment of the cloth was performed before printing on the cloth, as described below.

### [Printing on Doth Using Inkjet Recording Apparatus]

Printing was carried out using an inkjet printing apparatus (inkjet printer. “Calario (registered trademark) printer PX-045A” manufactured by Seiko Epson Corporation). The ink to be evaluated was filled in an ink cartridge corresponding to each ink color, and the ink cartridge was set in the inkjet printing apparatus. Next, an image (specifically, a solid image having a size of 60 mm*90 mm) was printed on a sheet of doth (polyester cloth, “Tropical” manufactured by Teijin Limited) using the inkjet printing apparatus. The cloth on which the image was printed was dried at a temperature of 20 degrees centigrade for 12 hours.

### [Post-Printing Heat Treatment]

A cloth on which an image was printed was heat-treated under the conditions of a temperature of 150 degrees centigrade a pressure of 0.20N/cm², and a treatment time of 00 seconds by using a press machine (“table-top automatic flat press machine AF-54 TEN type” manufactured by Asahi Textile Machinery Co., Ltd.), and the cloth after the heat treatment was used as an evaluation cloth.

### [Pretreatment of Cloth]

Only when ink (I-A4) was used the cloth was pre treated before printing. Specifically, a pretreatment solution having the following composition was applied to the cloth by the padding method. The cloth was then dried to obtain a pre-treated cloth having a drying rate of 50%. The drying rate was calculated by taking the mass of the cloth after the pretreatment solution was applied by the padding method as the mass at a drying rale of 0% and the mass of the cloth before the pretreatment solution was applied by the padding method as the mass at a drying rale of 100%.

### (Composition of the Pretreatment Liquid)

Polyallylamine (“PAA (registered trademark)-HCL-3A” manufactured by Niito-Bow Medical Co., Ltd.): 50 parts by mass

Glycerin: 80 parts by mass
1,2-hexanediol: 20 parts by mass
Polyether-modified polydimethylsiloxane (“BYK348” manufactured by Byk Japan K.K.): 10 parts by mass
Ion-exchanged water 840 parts by mass

### [Image Evaluation]

The evaluation cloth obtained in the above [Post-printing heat treatment] was subjected to loupe observation and visual observation, and the presence or absence of image defects in the image of the evaluation cloth was confirmed. The confirmed image defects include image streaks and unevenness in density. The image streaks are caused by nozzle clogging and ink ejection deviation from the nozzle. The image of the evaluation cloth was evaluated according to the following criteria based on the result of the confirmation of the presence or absence of image defects.

### (Image Evaluation Criteria)

Evaluation 5: No image defect is observed by either the loupe observation or the visual observation.
Evaluation 4: Some image defects are slightly confirmed loupe observation, but no image defect is confirmed by visual observation.
Evaluation 3: Image defects are clearly confirmed by loupe observation, but no image defect is confirmed by visual observation.
Evaluation 2: Image defects are clearly confirmed by loupe observation, and image defects are slightly confirmed by visual observation.
Evaluation 1: Image defects are dearly confirmed by both visual observation and loupe observation

### [Evaluation of Friction Fastness]

The friction fastness of the evaluation cloth obtained in the above [Post-printing heat treatment] was measured according to the Gakushin method (dry test method and wet test method) described in JIS (Japanese Industrial Standard) L-0849 (Method for testing color fastness to rubbing). The friction fastness obtained by the dry test method corresponds to the dry friction fastness, and the friction fastness obtained by the wet test method corresponds to the wet friction fastness.

In addition, as a judgment criterion of the degree of friction fastness, we adopted the “judgment criterion of discoloration” described in Clause 10 (Judgment of the degree of color fastness) of JIS L 0801 (General rules for test methods of color fastness) cited in JIS L-0849. This judgment criterion is a criterion of discoloration, which is judged by grade 1, grade 1 to grade 2 (i.e., more than grade 1 and less than grade 2), grade 2, grade 2 to grade 3 (i.e., more than grade 2 and less than grade 3), grade 3, grade 3 to grade 4 (i.e., more than grade 3 and less than grade 4), grade 4, grade 4 to grade 5 (i.e., more than grade 4 and less than grade 5), and grade 5 discoloration grade. In this evaluation, when the discoloration grade was 3 or higher, it was evaluated as “excellent in color fastness to friction”, and when the discoloration grade was lower than 3, it was evaluated as “not excellent in color fastness to friction”.

### [Tactile Feeling Evaluation]

The evaluation cloth obtained in the above [Post-printing heat treatment] was touched with a hand to evaluate the tactile feeling of the evaluation couth, and three items of stiffness, sliminess, and difficulty in swelling of the evaluation cloth were evaluated in three grades of A (good). B (normal), and C (poor), respectively, as the tactile feeling. The smaller the swelling of the evaluation cloth was, the better the item of the difficulty of swelling was evaluated. The tactile feeling of the evaluation cloth was evaluated according to the following criteria

### (Tactile Feeling Evaluation Criteria)

Evaluation 5: In the evaluation of three items, there are three A evaluations.
Evaluation 4: In the evaluation of three items, there are two A evaluations, and in the evaluation of three items, there is no C evaluation.
Evaluation 3: In the evaluation of three Hems, there is one A evaluation, and in the evaluation of three items, there is no C evaluation.
Evaluation 2: In the evaluation of three items, there is no A evaluation, and in the evaluation of three items, there are one or two C evaluations.
Evaluation 1: In the evaluation of three items, there are three C evaluations.

### <Evaluation Result>

For each of the inks (I-A1) to (I-A14) and (I-B1) to (I-B7), the result of evaluating the image, the result of determining the fastness to friction, and the result of evaluating the tactile feeling are shown in Table 6.

TABLE 6

| | | | Friction fastness | | |
|---|---|---|---|---|---|
| | | | Dry friction | Wet friction | |
| | | Image | fastness | fastness | Tactile |
| | Ink | evaluation | [Degree] | [Degree] | feeling |
| Example 1 | I-A1 | 4 | More than 3 | More than 3 | 4 |
| | | | and less than 4 | and less than 4 | |
| Example 2 | I-A2 | 4 | More than 3 | More than 3 | 4 |
| | | | and less than 4 | and less than 4 | |
| Example 3 | I-A3 | 5 | More than 3 | 3 | 4 |
| | | | and less than 4 | | |
| Example 4 | I-A4 | 5 | More than 3 | More than 3 | 4 |
| | | | and less than 4 | and less than 4 | |
| Example 5 | I-A5 | 4 | More than 3 | More than 3 | 3 |
| | | | and less than 4 | and less than 4 | |
| Example 6 | I-A6 | 5 | More than 3 | More than 3 | 4 |
| | | | and less than 4 | and less than 4 | |
| Example 7 | I-A7 | 5 | More than 4 | 4 | 4 |
| | | | and less than 5 | | |
| Example 8 | I-A8 | 5 | 5 | More than 4 | 3 |
| | | | | and less than 5 | |
| Example 9 | I-A9 | 5 | More than 4 | 4 | 4 |
| | | | and less than 5 | | |
| Example 10 | I-A10 | 4 | More than 4 | 4 | 3 |
| | | | and less than 5 | | |
| Example 11 | I-A11 | 4 | More than 4 | 4 | 3 |
| | | | and less than 5 | | |
| Example 12 | I-A12 | 4 | More than 3 | More than 3 | 4 |
| | | | and less than 4 | and less than 4 | |
| Example 13 | I-A13 | 4 | More than 3 | More than 3 | 4 |
| | | | and less than 4 | and less than 4 | |
| Example 14 | I-A14 | 4 | 4 | More than 3 | 3 |
| | | | | and less than 4 | |
| Comparison | I-B1 | 2 | 4 | 2 | 2 |
| example 1 | | | | | |
| Comparison | I-B2 | 3 | More than 2 | More than 1 | 3 |
| example 2 | | | and less than 3 | and less than 2 | |
| Comparison | I-B3 | 1 | 3 | 3 | 4 |
| example 3 | | | | | |
| Comparison | I-B4 | 4 | More than 2 | 2 | 3 |
| example 4 | | | and less than 3 | | |
| Comparison | I-B5 | 3 | More than 2 | 2 | 4 |
| example 5 | | | and less than 3 | | |
| Comparison | I-B6 | 3 | More than 3 | 3 | 1 |
| example 6 | | | and less than 4 | | |
| Comparison | I-B7 | 2 | 3 | 3 | 4 |
| example 7 | | | | | |

The inks (I-A1) to (I-A14) each had composite particles which were a composite of the specific polyester resins and the basic dye. In the inks (I-A1) to (I-A14), the specific polyester resins had a glass transition point of 40 degrees centigrade or higher and 70 degrees centigrade or lower. In the inks (I-A1) to (I-A14), the first repeating unit ratio of the specific polyester resin was 1.5 mol % or more and 10.0 mol % or less. In the inks (I-A1) to (I-A14), the acid value of the specific polyester resin was 15 mgKOH/g or more and 80 mgKOH/g or less. In the inks (I-A1) to (I-A14), the resin/dye ratio was 1.0 or more and 10.0 or less.

As shown in Table 6, with respect to the evaluation cloth on which images were printed using each of the inks (I-A1) to (I-A14), the image evaluation was 4 or more, the wet friction fastness was grade 3 or more, and the tactile feeling evaluation was 3 or more. Accordingly, each of the inks (I-A1) to (I-A14) was an ink capable of printing an image excellent in wet friction fastness while suppressing the occurrence of image defects, and capable of suppressing a decrease in the tactile feeling of a recording medium on which an image was printed.

In the ink (I-B1), the resin/dye ratio was more than 10.0. In the ink (I-B2), the first repeating unit ratio of the specific polyester resin was more than 10.0 mol %. In the inks (I-B3) and (I-B7), the acid value of the specific polyester resin was less than 15 mgKOH/g. In the ink (I-B4), the acid value of the specific polyester resin was more than 80 mgKOH/g. In the ink (I-B5), the glass transition point of the specific polyester resin was below 40 degrees centigrade. In the ink (I-B6), the glass transition point of the specific polyester resin was above 70 degrees centigrade.

As shown in Table 6, in the inks (I-B1), (I-B3), and (I-B7), the image evaluation was 2 or less, that is, in the case of using each of the inks (I-B1), (I-B3), and (I-B7), an image defect was confirmed by visual observation.

As shown in Table 6, the inks (I-B1), (I-B2), (I-B4)), and (I-B5), the wet friction fastness was less than grade 3. Therefore, the images printed using each of the inks (I-B1), (I-B2), (I-B4), and (I-B5) were not excellent in the wet friction fastness.

As shown in Table 6, in the inks (I-B1) and (I-B6), the tactile feeling evaluation was 2 or less, that is the images printed using each of the inks (I-B1) and (I-B6) bad one or more C evaluations (poor).

From the above results, it was shown that according to the ink of the present disclosure, it is possible to print an image excellent in wet friction fastness while suppressing the occurrence of image defects, and it is also possible to suppress a decrease in the tactile feeling of a recording medium on which an image is printed.

What is claimed is:

1. An inkjet ink comprising an aqueous medium and composite particles, wherein
the composite particles are particles of a composite of a polyester resin having a sulfonic acid group and a basic dye,
a glass transition point of the polyester resin is 40 degrees centigrade or higher and 70 degrees centigrade or lower,
wherein the polyester resin has a first repeating unit derived from a polycarboxylic acid having the sulfonic acid group, a second repeating unit derived from a polycarboxylic acid having no sulfonic acid group, and a third repeating unit derived from a polyhydric alcohol
a content ratio of the first repeating unit to a total amount of the first repeating unit and the second repeating unit is 1.5 mol % or more and 10.0 mol % or less,
an acid value of the polyester resin is 15 mgKOH/g or more and 80 mgKOH/g or less, and
a mass ratio of the polyester resin to the basic dye is 1.0 or more and 10.0 or less.

2. The inkjet ink according to claim 1, wherein in the composite particle, the basic dye and the sulfonic acid group included in the polyester resin are bonded by an ionic bond.

3. The inkjet ink according to claim 1, wherein the first repeating unit includes at least one repeating unit selected from the group consisting of a repeating unit derived from 5-sodium sulfoisophthalic acid and a repeating unit derived from 4-sulfophthalic acid.

4. The inkjet ink according to claim 1, further comprising a first additive, wherein
the first additive is a compound capable of reacting with at least one functional group selected from the group consisting of a hydroxyl group a carboxyl group, and an amino group by heating.

5. The inkjet ink according to claim 4, wherein the first additive is a blocked isocyanate, a polymer having an oxazoline group, a compound having an epoxy group, or a polycarbodiimide.

6. The inkjet ink according to claim 1, further comprising a second additive, wherein
the second additive is an ultraviolet absorber including a benzotriazole structure or an ultraviolet absorber including a hydroxyphenyltriazine structure.

7. The inkjet ink according to claim 1, wherein a conductivity of a dispersion liquid when the composite particles are dispersed in water at a concentration of 5% by mass is 30 μS/cm or less.
